(19) United States
(12) Patent Application Publication
(10) Pub. No.: US 2007/0057632 A1
(43) Pub. Date: Mar. 15, 2007

(54) Plasma display panel

(76) Inventors: Taewoo Kim, Yongin-si (KR); Sanghoon Yim, Yongin-si (KR)

Correspondence Address: CHRISTIE, PARKER & HALE, LLP, PO BOX 7068, PASADENA, CA, 91109-7068, US

(21) Appl. No.: 11/512,718

(22) Filed: Aug. 29, 2006

(30) Foreign Application Priority Data
Aug. 30, 2005 (KR) 10-2005-0080064

(51) Int. Cl. H01J 1/62

(52) U.S. Cl. 313/506

(57) ABSTRACT

A plasma display panel having two address electrodes assigned to each pixel to reduce power consumption without degrading resolution, the address electrodes having a large line width to improve address discharge efficiency. In one embodiment, three neighboring discharge cells for emitting different colors of visible rays define a pixel, two address electrodes are assigned to each pixel, and the address electrodes have a line width not less than a length of a side of a plurality of barriers defining the discharge cells. In the embodiment, the line width of the address electrodes may range from about 90 to about 150 μm.

### CROSS-REFERENCE TO RELATED APPLICATION

The present application claims priority to and the benefit of Korean Patent Application No. 10-2005-0080064, filed on Aug. 30, 2005, in the Korean Intellectual Property Office, the entire content of which is incorporated herein by reference.

### BACKGROUND OF THE INVENTION

1. Field of the Invention

The present invention relates to a plasma display panel, and more particularly, to a plasma display panel having two address electrodes assigned to each pixel to reduce power consumption without degrading resolution, the address electrodes having a large line width to improve address discharge efficiency.

2. Description of the Related Art

A plasma display panel includes a front glass substrate incorporated with a number of display electrodes and a rear glass substrate incorporated with a number of address electrodes. The address electrodes cross (or intersect with) the display electrodes. A number of barriers are formed between the front and rear glass substrates to define a number of discharge cells. Three neighboring (or adjacent) discharge cells, which emit different colors of visible rays, can be used to define a pixel. Each of the three neighboring discharge cells has one red, green, or blue fluorescent layers formed thereon. In general, each pixel has three address electrodes assigned thereto. As a result, each of the three neighboring discharge cell has its own address electrode assigned thereto.

For better plasma display panel resolution, as the number of address electrodes gradually increases, the pitch between the address electrodes should decrease. However, when the pitch between the address electrodes decreases, the capacitance between the address electrodes increases, and the amount of energy or power (CV²f) consumed between the address electrodes is also increased. Thus, in order to manufacture high-resolution plasma display panels, the power (CV²f) consumed by address electrodes increases. In addition, increase in power consumption of the address electrodes is directly connected to increase in overall power consumption of the plasma display panel, because the discharge voltage applied to the address electrodes is larger than the voltage applied to the display electrodes. In the above, C refers to capacitance created between the address electrodes, V refers to voltage applied to the address electrodes, and f refers to frequency applied to the address electrodes.

Also, as the distance between the address electrodes decreases, severe crosstalk may occur. In addition, circuits (e.g., tape carrier packages) for applying a voltage to the address electrodes need to endure larger instantaneous power (or peak power), and the amount of heat generated by the circuits or panels increases as the number of address electrode increases.

A typical line width of the address electrodes is from 70 to 90 μm, and reflects the reduction in size of the discharge cells. The address electrodes cross (or intersect with) the display electrodes. During addressing of selected discharge cells, address discharges occur in regions (discharge cells or discharge regions) where the address electrodes cross (or intersect with) the display electrodes.

In order to obtain desired discharge efficiency, a line width of the address electrodes should be equal to or larger than about 100 μm. However, as mentioned above, the typical line width of the address electrodes is less than 100 μm because the size of the discharge cells is small. This degrades the address discharge efficiency. Such degradation may result in addressing failure and cause specific discharge cells to malfunction. In an attempt to improve the discharge efficiency, a larger address voltage may be applied to the address electrodes. However, the larger the address voltage is, the more severe crosstalk becomes. This may generate erroneous discharge. In addition, the instantaneous voltage of circuits for driving the address electrodes also increases. This increases power consumption.

Furthermore, in order to compensate for poor discharge efficiency, a longer period of addressing time is assigned to select discharge cells. However, the longer the addressing time is, the shorter the display discharge time becomes. This degrades the luminance, contrast, and optical efficiency of the plasma display panel.

### SUMMARY OF THE INVENTION

An aspect of the present invention provides a plasma display panel having two address electrodes assigned to each pixel to reduce power consumption without degrading resolution, the address electrodes having a large line width to improve address discharge efficiency.

In one embodiment, there is provided a plasma display panel including a front glass substrate; a number of display electrodes formed on a surface of the front glass substrate; a rear glass substrate positioned so as to face the front glass substrate; a number of address electrodes formed on a surface of the rear glass substrate, the address electrodes crossing the display electrodes, the surface of the rear glass substrate facing the front glass substrate; and a number of discharge cells formed in regions of the rear glass substrate defined by barriers having a thickness to emit colors of visible rays, the display and address electrodes crossing each other in the regions, wherein three neighboring ones of the discharge cells for emitting different colors of the visible rays define a pixel, wherein two of the address electrodes are assigned to each pixel, and wherein the address electrodes have a line width not greater than a length of a side of the barriers defining the discharge cells.

Since two address electrodes are assigned to a pixel including three discharge cells, the number of address electrodes of the plasma display panel according to an embodiment of the present invention can be reduced as compared with the prior art. Particularly, the number of address electrodes of the plasma display panel according to an embodiment of the present invention is reduced to about ⅔ of the prior art.

Such reduction of the number of address electrodes is followed by reduction of power consumption of the address electrodes to about ⅔ of the prior art.

In addition, the instantaneous power (or peak power), which must be endured by a circuit for driving the address electrodes, is reduced to about ⅔ of the prior art.

As a smaller number of address electrodes are used while maintaining the same resolution, the distance between the address electrodes increases. This substantially reduces crosstalk among the address electrodes, as well as heat generation.

The line width of the address electrodes of the plasma display panel according to an embodiment of the present invention is substantially larger than that of the prior art (for example, the line width of the address electrodes ranges from 80 to 120% of a length of a side of the barriers, ranges from 40 to 60% of a maximum width of the discharge cells, and/or ranges from 90 to 150 μm) to improve the discharge efficiency during addressing discharge. This is because increase in the line width of the address electrodes increases the discharge area. Such improvement of the address discharge efficiency assists (or ensures or guarantees) addressing of selected discharge cells, as well as following display discharge. In addition, such improvement of the address discharge efficiency reduces power consumption and the burden on circuits for driving the address electrodes, because the address voltage does not need to be increased very much.

The addressing time is shortened by such improvement of the addressing discharge efficiency. Consequently, the display discharge time can be increased by as much as the addressing time is shortened. This improves the luminance, contrast, and optical efficiency of the plasma display panel.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a partially broken perspective view showing a plasma display panel according to an embodiment of the present invention;

FIG. 2 shows a relationship between discharge cells and address electrodes on a rear glass substrate of a plasma display panel according to an embodiment of the present invention;

FIG. 3 is a sectional view taken along line 1-1 of the rear glass substrate of the plasma display panel shown in FIG. 1; and

FIG. 4 shows a relationship between address electrodes and three discharge cells, which constitute a pixel, on a rear glass substrate of a plasma display panel according to an embodiment of the present invention.

### DETAILED DESCRIPTION

In the following detailed description, only certain exemplary embodiments of the present invention are shown and described, by way of illustration. As those skilled in the art would recognize, the described exemplary embodiments may be modified in various ways, all without departing from the spirit or scope of the present invention. Accordingly, the drawings and description are to be regarded as illustrative in nature, and not restrictive.

There may be parts shown in the drawings, or parts not shown in the drawings, that are not discussed in the specification as they are not essential to a complete understanding of the invention. Like reference numerals designate like elements.

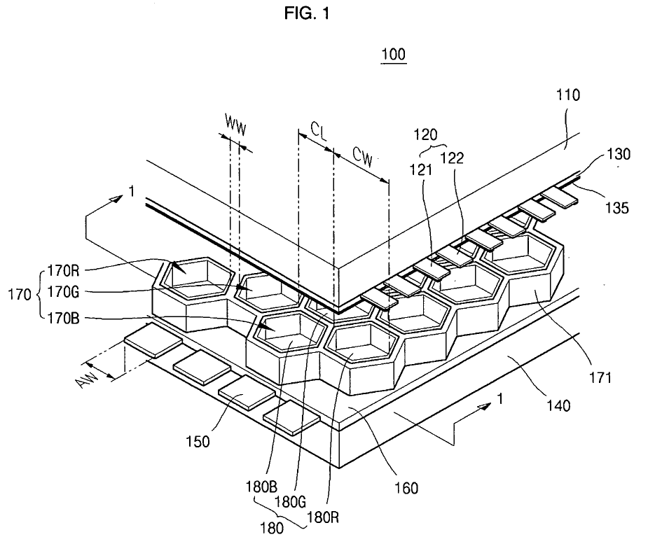

FIG. 1 is a partially broken perspective view showing a plasma display panel according to an embodiment of the present invention.

As shown in FIG. 1, the plasma display panel 100 includes a front glass substrate 110; a number of display electrodes 120 formed on the front glass substrate 110; a first dielectric layer 130 covering the display electrodes 120; a rear glass substrate 140 positioned so as to face the front glass substrate 110; a number of address electrodes 150 formed on the rear glass substrate 140; a second dielectric layer 160 covering the address electrodes 150; a number of discharge cells 170 defined on the second dielectric layer 160 by barriers 171, the barriers 171 having a thickness (which may be predetermined); and fluorescent layers 180 formed in the respective discharge cells 170.

The front glass substrate 110 may be made of an approximately planar material, such as PD 200 glass, soda lime glass, plastic, or an equivalent thereof, which has a good heat-resistance and a high strain point to retain its desired dimension and shape in various high-temperature processes, but the material of the present invention is not thereby limited.

The display electrodes 120 are formed on the lower surface of the front glass substrate 110 with a pitch (which may be predetermined) while being parallel to one another. For example, the display electrodes 120 are arranged in a number of rows with a predetermined pitch. Each of the display electrodes 120 has a scan electrode 121 and a sustain electrode 122. The display electrodes 120 may be made of ITO (oxide film of alloy of In and Sn), Nesa film (SnO₂), or an equivalent thereof, which has good optical transmittance and electrical conductivity, by sputtering, but the material and formation method of the present invention are not thereby limited. The display electrodes 120 may have low-resistance bus electrodes formed on a surface thereof, in order to avoid a voltage drop, using Cr—Cu—Cr, Ag, or an equivalent thereof, but the material of the present invention is not thereby limited.

The first dielectric layer 130 covers the entire lower surface of the front glass substrate 110, including the display electrodes 120. The first dielectric layer 130 may be uniformly formed by a screen-printing paste, which includes low melting point glass as its main component, on the entire lower surface of the front glass substrate 110. As known by those skilled in the art, the first dielectric layer 130 is transparent and functions as a capacitor during discharge. In addition, the first dielectric layer 130 limits the current and acts as a memory. The first dielectric layer 130 may have a protective film 135 formed on a surface thereof to reinforce durability and discharge more secondary electrons during discharge. The protective film 135 may be made of MgO or an equivalent thereof in an electron beam mode or by sputtering. However, the material and formation method of the protective film of the present invention are not thereby limited.

The rear glass substrate 140 is positioned so as to face the front glass substrate 110. Particularly, the rear glass substrate 140 is positioned below the first dielectric layer 130. The rear glass substrate 140 may be made of an approximately planar material, such as PD 200 glass, soda lime glass, plastic, or an equivalent thereof, which has good heat-resistance and high strain point enough to retain its desired dimension and shape in various high-temperature processes, but the material of the present invention is not thereby limited.

The address electrodes 150 are formed on the upper surface of the rear glass substrate 140, which faces the first dielectric layer 130 of the front glass substrate 110. The address electrodes 150 are formed on the upper surface of the rear glass substrate 140 with a pitch (which may be predetermined) while being parallel to one another. For example, the address electrodes 150 are arranged in a number of rows with a predetermined pitch. The address electrodes 150 cross (or intersect with) the display electrodes 120. The address electrodes 150 may be substantially perpendicular to the display electrodes 120. As will be described later, each of the address electrodes 150 crosses (or intersects with) corresponding discharge cells 170, which emit different colors of visible rays, or different fluorescent layers 180. The address electrodes 150 may be made of an Ag paste or an equivalent thereof by sputtering, a screen printing method, or photolithography, but the material and formation method of the address electrodes 150 are not thereby limited. The interconnection between the address electrodes 150 and the discharge cells 170 will be described later in more detail.

The second dielectric layer 160 covers the entire upper surface of the rear glass substrate 140, including the address electrodes 150. The second dielectric layer 160 may be made of a similar or identical material as that of the first dielectric layer 130.

The discharge cells 170 are defined on a surface of the second dielectric layer 160 by the barriers 171 having a thickness. For example, the discharge cells 170 are formed at regions, where display electrodes 120 and address electrodes 150 cross (or intersect with) each other, in an approximately matrix configuration. The discharge cells 170 may have a have a triangular, square, lozenge, pentagon, hexagon, or polygon shape. Although hexagonal closed-type discharged cells 170 are shown in the drawing, the shape of the present invention is not thereby limited, and the present invention can be applied to all suitable kinds of closed-type discharge cells 170. The barriers 171 maintain a spacing between the front and rear glass substrates 110 and 140 and define the discharge cells 170, as mentioned above. The barriers 171 may be made of low melting point glass powder paste or an equivalent thereof by a screen printing method, a sand blast method, a lift-off method, or an etching method, but the material and formation method of the barriers 171 are not thereby limited. In the drawing, a red discharge cell 170R is for emitting red light, a green discharge cell 170G is for emitting green light, and a blue discharge cell 170B is for emitting blue light.

The fluorescent layers 180 are formed on the inner wall of the discharge cells 170 (or inner wall of the barriers 171) and on the second dielectric layer 160 with a thickness (which may be predetermined). The fluorescent layers 180 are excited by UV rays, which are generated during plasma discharges, and emit colors of visible rays (and the colors may be predetermined). The red, green, and blue discharge cells 170R, 170G, and 170B have red, green, and blue fluorescent layers 180R, 180G, and 180B formed therein, respectively.

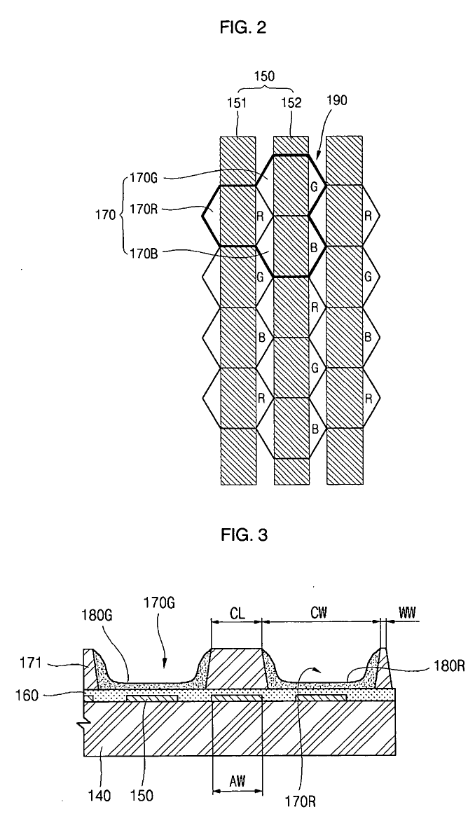

FIG. 2 shows a relationship between discharge cells and address electrodes on a rear glass substrate of a plasma display panel according to an embodiment of the present invention.

As shown in FIG. 2, three neighboring (or adjacent) discharge cells 170R, 170G, and 170B define a pixel 190 (indicated by solid lines) and have two address electrodes 151 and 152 assigned thereto. In contrast, three address electrodes are assigned to three neighboring (or adjacent) discharge cells (i.e. a pixel) according to the prior art. As such, the number of address electrodes according to the embodiment of the present invention is reduced to ⅔ of the prior art. More particularly, according to the embodiment of the present invention, one of the three neighboring discharge cells has one address electrode assigned thereto and two remaining discharge cells have another address electrode assigned thereto. For example, a red discharge cell 170R (or red fluorescent layer) has an address electrode (or a first address electrode) 151 assigned thereto, and green and blue discharge cells 170G and 170B (or green and blue fluorescent layers), which are adjacent to the red discharge cell 170R, have an address electrode (or a second address electrode) 152 commonly assigned thereto. Sets of red, green, and blue discharge cells 170R, 170G, and 170B (or red, green, and blue fluorescent layers) are repeatedly and alternatively arranged along the address electrode 151. Similarly, a number of discharge cells 170R, 170G, and 170B are repeatedly and alternatively arranged along the address electrode 152.

As such, since two address electrodes 150 are assigned to each pixel 190, the number of address electrodes 150 of the plasma display panel 100 according to the embodiment of the present invention is reduced to ⅔ of the prior art (and so is the power consumption). As a result, the instantaneous power (or peak power), which should be endured by a circuit for driving the address electrodes 150, can be reduced to ⅔ of the prior art. In addition, the ratio of heat emission from the plasma display panel 100 is substantially reduced.

As the number of address electrodes 150 decreases in the same area, the pitch among them thereby increases and crosstalk among them is thereby substantially reduced.

Because of the reduction in number of the address electrodes 150 and the resulting increase in pitch of the address electrodes 150, the line width of the address electrodes 150 can increase, as will be described later.

FIG. 3 is a sectional view taken along line 1-1 of the rear glass substrate 140 of the plasma display panel 100 shown in FIG. 1.

As shown, the rear glass substrate 140 includes a number of address electrodes 150 formed on the upper surface thereof with a pitch (which may be predetermined); a second dielectric layer 160 formed on the rear glass substrate 140 and the address electrodes 150 with a thickness (which may be predetermined); discharge cells 170 defined on the second dielectric layer 160 by barriers 170 having a thickness (which may be predetermined); and fluorescent layers 180 formed in the respective discharge cells 170. In FIG. 3, red and green discharge cells 170R and 170G are shown as the discharge cell 170, and red and green fluorescent layers 180R and 180G are shown as the fluorescent layers 180.

FIG. 3 also shows a line width AW of the address electrodes 150, a line width WW of the barriers 171 defining the discharge cells 170, a length CL of a side of the barriers 171, and a maximum width CW of the discharge cells 170.

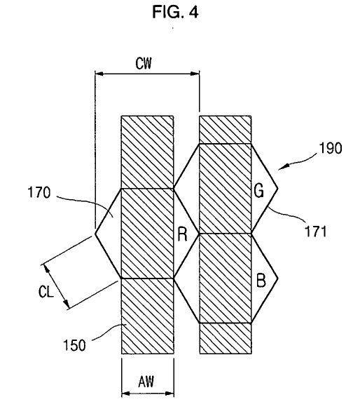

FIG. 4 shows a relationship between address electrodes and three discharge cells, which constitute a pixel, on a rear glass substrate of a plasma display panel according to an embodiment of the present invention. FIG. 4 will now be referred together with FIG. 3.

As shown, the line width AW of the address electrodes 150 is larger than the line width WW of the barriers 171, which constitute the discharge cells 170, but smaller than the maximum width CW of the discharge cells 170. The maximum width CW of the discharge cells 170 refers to the distance between two vertices of the barriers 171, which are farthest from each other. The discharge cells 170 may include barriers 171 having a hexagonal planar shape. In other words, the barriers 171 defining (or constituting) the discharge cells 170 may have six sides. The address electrodes 150 may be positioned in such a manner that their longitudinal direction is approximately perpendicular to two sides of the barriers 171 defining (or constituting) the discharge cells 170.

More particularly, the line width AW of the address electrodes 150 may range from about 80 to about 120% of the length CL of the side of the barriers 171. If the line width AW of the address electrodes 150 is smaller than 80% of the length CL of the side of the barriers 171, the area of superposition with the display electrodes decreases and the address discharge efficiency degrades. If the line width AW is larger than 120% of the length CL, the address electrodes 150 may interfere with adjacent discharge cells 170 and induce discharge in unwanted regions.

From a different point of view, the line width AW of the address electrodes 150 may range from about 40 to about 60% of the maximum width CW of the discharge cells 170. If the line width AW of the address electrodes 150 is smaller than 40% of the maximum width CW of the discharge cells 170, the area of superposition with the display electrodes decreases and the address discharge efficiency degrades, as mentioned above. If the line width AW is larger than 60% of the maximum width CW, the address electrodes 150 may interfere with adjacent discharge cells 170 and induce discharge in unwanted regions.

In the case of a full HD grade plasma display panel having a resolution of 1920×1080, for example, the line width AW of the address electrodes 150 may range from about 90 to about 150 μm. If line width AW is smaller than 90 μm, which is in the line width range according to the prior art, the address discharge efficiency degrades. If the line width AW is larger than 150 μm, the address electrodes 150 may interfere with adjacent discharge cells and induce discharge in unwanted regions.

In one reference embodiment, a discharge cell 170 may have a maximum or transverse width CW ranging from about 200 to about 290 μm, and an area of an address electrode 150 may occupy about 40 to about 60% of an area inside a corresponding discharge cell 170.

As is known by those skilled in the art, a frame for displaying images in a plasma display panel includes a number of sub-fields, each of which includes reset, address, and sustain periods.

In the reset period, the voltage of scan electrodes 121 of the display electrodes 120 is gradually increased to a voltage (a first predetermined voltage) and is then gradually decreased to another voltage (a second predetermined voltage) to erase the wall charge of all discharge cells 170, while maintaining the voltage of address electrodes 150 at a reference voltage (e.g. 0V). This avoids erroneous discharge of the discharge cells 170 in the sustain period, when they do not perform address discharge in the address period.

In the address period, scan and address pulses having respective (or predetermined) voltages are applied to selected scan and address electrodes 121 and 150, respectively, in order to select which discharge cells 170 to turn on. Then, selected discharge cells 170 generate discharge between the address and scan electrodes 150 and 121, so that positive (+) wall charge is formed on the scan electrodes 121 and negative (−) wall charge is formed on the address and sustain electrodes 150 and 122. As a result, a wall voltage is formed between the scan and sustain electrodes 121 and 122 in such a manner that the scan electrodes 121 have a higher electrical potential than that of the sustain electrodes 122.

The structure of the address electrodes 150 having an increased line width AW, compared with the prior art, increases the discharge area with the scan electrodes 121 and improves the address discharge efficiency. Such improvement of the address discharge efficiency assists (ensures or guarantees) addressing of selected discharge cells 170, as well as following sustain discharge. In addition, such improvement of the address discharge efficiency reduces power consumption and the burden on circuits for driving the address electrodes 150, because the address voltage does not need to be increased very much. Furthermore, the addressing time is shortened by such improvement of the addressing discharge efficiency, thereby realizing a faster addressing (or a faster addressing speed or rate). Consequently, the display discharge time can be increased by as much as the addressing time is shortened. This improves the luminance, contrast, and optical efficiency of the plasma display panel.

In the sustain period, pulses having a voltage (which may be predetermined) are applied to scan electrodes 121 of the discharge cells 170, which have generated address discharge, in order to generate sustain discharge between the scan and sustain electrodes 121 and 122. As a result of the sustain discharge, negative wall charge is formed on the scan electrodes 121 and positive wall charge is formed on the sustain and address electrodes 122 and 150, so that the sustain electrodes 122 have a higher wall voltage than that of the scan electrodes 122. Then, pulses having a negative voltage are applied to the scan electrodes 121 to generate sustain discharge between the scan and sustain electrodes 121 and 122. Consequently, positive wall charge is formed on the scan electrodes 121 and negative wall charge is formed on the sustain and address electrodes 122 and 150, so that sustain discharge can readily occur when a voltage (which may be predetermined) is applied to the scan electrodes 121. Thereafter, the processes of applying sustain discharge pulses having a voltage (which may be predetermined) to the scan and sustain electrodes 121 and 122 and applying sustain discharge pulses having a negative voltage thereto are repeated as often as the weight value indicated by the corresponding sub-field. It is to be noted that the above description on the reset, address, and sustain periods is only an example, and they may be modified as desired.

As mentioned above, since two address electrodes are assigned to a pixel including three discharge cells, the number of address electrodes of the plasma display panel according to an embodiment of the present invention can be reduced as compared with the prior art. Particularly, the number of address electrodes of the plasma display panel according to an embodiment of the present invention is reduced to about ⅔ of the prior art.

Such reduction of the number of address electrodes is followed by reduction of power consumption of the address electrodes to about ⅔ of the prior art.

In addition, the instantaneous power (or peak power), which must be endured by a circuit for driving the address electrodes, is reduced to about ⅔ of the prior art.

As a smaller number of address electrodes are used while maintaining the same resolution, the distance between the address electrodes increases. This substantially reduces crosstalk among the address electrodes, as well as heat generation.

The line width of the address electrodes of the plasma display panel according to an embodiment of the present invention is substantially larger than that of the prior art (for example, the line width of the address electrodes ranges from 80 to 120% of the side of the discharge cells, ranges from 40 to 60% of the maximum width of the discharge cells, and/or ranges from 90 to 150 μm) to improve the discharge efficiency during addressing discharge. This is because increase in the line width of the address electrodes increases the discharge area. Such improvement of the address discharge efficiency assists (or ensures or guarantees) addressing of selected discharge cells, as well as following display discharge. In addition, such improvement of the address discharge efficiency reduces power consumption and the burden on circuits for driving the address electrodes, because the address voltage does not need to be increased very much.

The addressing time is shortened by such improvement of the addressing discharge efficiency. Consequently, the display discharge time can be increased by as much as the addressing time is shortened. This improves the luminance, contrast, and optical efficiency of the plasma display panel.

While the invention has been described in connection with certain exemplary embodiments, it is to be understood by those skilled in the art that the invention is not limited to the disclosed embodiments, but, on the contrary, is intended to cover various modifications included within the spirit and scope of the appended claims and equivalents thereof.

What is claimed is:

1. A plasma display panel comprising:
a front glass substrate;
a plurality of display electrodes formed on a surface of the front glass substrate;
a rear glass substrate positioned so as to face the front glass substrate;
a plurality of address electrodes formed on a surface of the rear glass substrate, the address electrodes crossing the display electrodes, the surface of the rear glass substrate facing the front glass substrate; and
a plurality of discharge cells formed in regions of the rear glass substrate defined by a plurality of barriers having a thickness to emit colors of visible rays, the display and address electrodes crossing each other in the regions,
wherein three neighboring ones of the discharge cells for emitting different colors of the visible rays define a pixel, wherein two of the address electrodes are assigned to each pixel, and wherein the address electrodes have a line width not greater than a length of a side of the barriers defining the discharge cells.

2. The plasma display panel as claimed in claim 1, wherein at least one of the address electrodes is commonly assigned to two of the three neighboring ones of the discharge cells defining the pixel, and wherein another one of the address electrodes is assigned to the remaining one of the three neighboring ones of the discharge cells defining the pixel.

3. The plasma display panel as claimed in claim 1, wherein the discharge cells defined by the barriers is a closed cell.

4. The plasma display panel as claimed in claim 3, wherein the address electrodes are positioned so that two sides of the barriers defining the discharge cells are approximately perpendicular to a longitudinal direction of the address electrodes.

5. The plasma display panel as claimed in claim 1, wherein the line width of the address electrodes ranges from about 80 to about 120% of the length of the side of the barriers.

6. The plasma display panel as claimed in claim 1, wherein the line width of the address electrodes ranges from about 40 to about 60% of a maximum width of the discharge cells.

7. The plasma display panel as claimed in claim 1, wherein the line width of the address electrodes ranges from about 90 to about 150 μm.

8. The plasma display panel as claimed in claim 1, wherein the discharge cells have a maximum width ranging from about 200 to about 290 μm.

9. The plasma display panel as claimed in claim 1, wherein an area of one of the address electrodes occupies about 40 to about 60% of an area inside a corresponding one of the discharge cells.

10. A plasma display panel comprising:
a glass substrate;
a plurality of address electrodes formed on a surface of the glass substrate;
a plurality of discharge cells formed in regions of the glass substrate defined by a plurality of barriers,
wherein three neighboring ones of the discharge cells for emitting different colors of the visible rays define a pixel, and wherein only two of the address electrodes are assigned to each pixel.

11. The plasma display panel as claimed in claim 10, wherein at least one of the address electrodes is commonly assigned to two of the three neighboring ones of the discharge cells defining the pixel, and wherein another one of the address electrodes is assigned to the remaining one of the three neighboring ones of the discharge cells defining the pixel.

12. The plasma display panel as claimed in claim 10, wherein the address electrodes have a line width not greater than a length of a side of the barriers defining the discharge cells

13. The plasma display panel as claimed in claim 10, wherein each of the discharge cells defined by the barriers is a closed cell.

14. The plasma display panel as claimed in claim 13, wherein the address electrodes are positioned so that two sides of the barriers defining the discharge cells are approximately perpendicular to a longitudinal direction of the address electrodes.

15. The plasma display panel as claimed in claim 10, wherein the address electrodes have a line width ranging from about 80 to about 120% of a length of a side of the barriers.

16. The plasma display panel as claimed in claim 10, wherein the address electrodes have a line width ranging from about 40 to about 60% of a maximum width of the discharge cells.

17. The plasma display panel as claimed in claim 10, wherein the address electrodes have a line width ranging from about 90 to about 150 μm.

18. The plasma display panel as claimed in claim 10, wherein the discharge cells have a maximum width ranging from about 200 to about 290 μm.

19. The plasma display panel as claimed in claim 10, wherein an area of one of the address electrodes occupies about 40 to about 60% of an area inside a corresponding one of the discharge cells.
